(19) United States
(12) Patent Application Publication
(10) Pub. No.: US 2011/0222722 A1
(43) Pub. Date: Sep. 15, 2011

(54) LOUDSPEAKER WITH DISTRIBUTED DRIVING OF THE MEMBRANE

(76) Inventor: Lennart Hoglund, Linkoping (SE)

(21) Appl. No.: 13/112,309

(22) Filed: May 20, 2011

Related U.S. Application Data
(63) Continuation-in-part of application No. 11/569,672, filed on Nov. 27, 2006, now Pat. No. 7,970,158.

(30) Foreign Application Priority Data
May 28, 2004 (SE) 0401365-2

(51) Int. Cl. H04R 1/00

(52) U.S. Cl. 381/423

(57) ABSTRACT

The membrane of a loudspeaker, which is driven on a limited part of the membrane, does not move completely like the tone current. For example, a cone, which is driven in the top, provides more accurate driving by also being driven in the periphery from the drive system back where the movement of the sound coil also is taken out. The driving can e.g. be distributed with a cone of net. With separate sound coils from the front side and back side of the driving system, the loudspeaker properties can be optimised. The biggest benefit is achieved with a long loudspeaker where the movement is taken out from the back side of the long drive system and distributed with plates, cones and wavy walls to a bulgy membrane edges.

### PRIOR APPLICATION

This is a continuation-in-part patent application that claims priority from US patent application Ser. No. 11/569,672 filed 27 Nov. 2006 that claims priority from International Application No. PCT/SE2005/000772, filed 25 May 2005, claiming priority from Swedish Patent Application No. 0401365-2, filed 28 May 2004.

### BACKGROUND AND SUMMARY OF THE INVENTION

There is too much sound produced today causes damage to the ear. In the ear there are muscles which can be tired. Therefore, after a period of exposure, injures may arise from reasonable high sound levels.

One object of the present invention is to produce a sound system which with high quality only gives off the sound level needed at all places in the whole space intended.

A long and narrow loudspeaker along a whole wall has the following advantages:

The listeners closest to the sound system are all exposed to the same sound levels.

No or only insignificant reflections arise from the side walls if the room has right angles in the corners.

The sound pressure drops relatively slowly so that listeners at distance from the loudspeaker maintain a good sound level without the nearest listeners having to be exposed to painfully high levels.

A section of the loudspeaker only needs to deliver sound to a slice of air in front of the section, which means that the membrane only needs to deliver relatively low sound pressures, which imply small amplitudes.

The air retains its linear properties, so distortion caused by high sound pressure does not occur. The sound coil movement gets small amplitude, so that the distortion in the driving system will be low.

If one wants to further improve the propagation of the sound, it can be relatively easily reflected and bent because the material for this will have cylindrical surfaces. Driving systems with reduced force may be used e. g. reduced magnetic field in electro-dynamic driving system. Even geomagnetic fields may be used if they are at first concentrated.

A conventional electro-dynamic loudspeaker has the cone as membrane. This is driven by the coil with current in the ring formed air gape with the magnetic flux from the magnetic device, which sits in the basket bottom, which the membrane edges via the outer suspension sits in the basket edges.

The basic problem of conventional loudspeakers is that the cone in order to produce bas tones shall be large, at which the treble tones at the best make a propagating wave outwards in the cone.

In order to reduce the problem, a driving unit may be used where the movement is taken out from two places. The membrane is then driven at the center from the driving unit outer end, while the membrane is driven at the periphery respective along the edges from the drive unit inner end.

### BRIEF DESCRIPTION OF THE DRAWINGS

FIG. 1 shows three horizontally placed long and narrow loudspeakers on a wall, which produce angle stereo in the entire room.

FIG. 2 shows a side-view of an example of a horizontally placed long and narrow loudspeaker composed of a number of membranes which together form a half cylinder and a speaker with only one membrane.

FIG. 3 shows how a long loudspeaker is made of flux catchers of iron plates, which catch geomagnetic fields and via flux conductors distribute the field across long membranes, which conduct the sound current.

FIG. 4 shows how long, narrow and bent loudspeakers placed along and across walls in a winding passage give winding phase front but yet smooth, sound level, which reduces strong and unnecessary scattering.

FIG. 5 shows how an anisotropic prism redirects sound.

FIG. 6 shows a principle of the membrane, drive units and drive distributor of the present invention.

FIG. 7 shows the details in a round loudspeaker that is provided with drive distributor.

FIG. 8 shows the details in an elongate loudspeaker provided with drive distributor and a long loudspeaker driven by 4 bands in magnetic air gaps.

FIG. 9 shows an alternative embodiment including driving units with cog plate.

FIG. 10 shows another alternative embodiment including a driving unit with two separate coils.

FIG. 11 shows a driving unit with 2 coils on the same tube.

### DETAILED DESCRIPTION

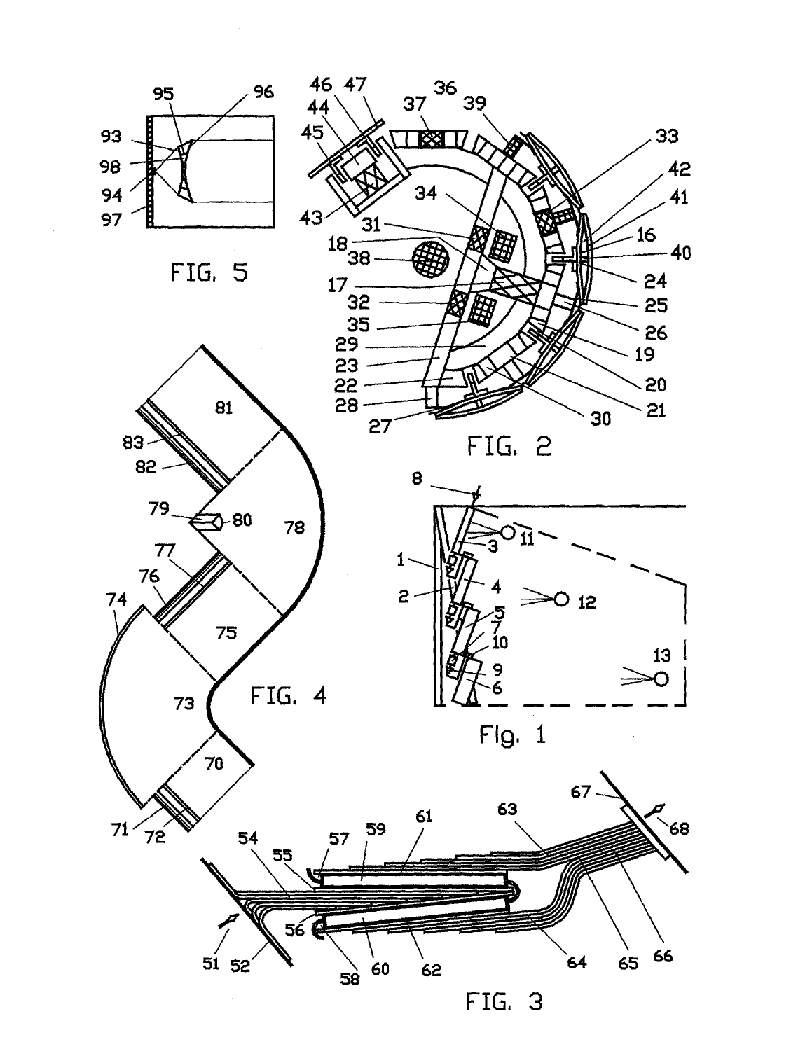

FIG. 1 shows a long, narrow loudspeaker 1 on a wall. The loudspeaker follows the waff and gives off the sound in a straight forward direction. The loudspeaker 2 has the left end moved forward, causing the sound to be somewhat directed to the right. This gives a stereo sound with two distinct directions as to where the sound is coming from and is much more independent of ones location in the room than would be expected using concentrated loudspeakers.

If the loudspeakers encroach on the space one can mount loudspeaker elements 3, 4, 5 and 6 directed in the same angle but in a row against the wall. These elements are in themselves long and narrow loudspeakers, which mean that the membrane is long and narrow. The sound is delayed between the loudspeaker elements with e. g. an electronic delay 7 between them, so that the wave front is straight but directed obliquely forward. The signal enters the first element by an amplifier 8 and to every element there are suitable amplifiers 9. Between the elements there is a partition wall 10. All the listeners 11, 12 and 13 now receive a sound source coming from the right. In order to more exactly adapt the waves between the elements they can be made with different widths.

It is quite easy to increase the distribution of sound from a long and narrow loudspeaker, even to the extent that it becomes circular, which is shown in FIG. 2 as a cross-section. There are at first long parallel membranes 16, which direct the sound respectively in their own direction. A long preferable permanent magnet 17 feed its flux from its own long side, which lies against the one side on an equally long flux distributing rod 18, to the middle line on an oblique made thin side of a long plate 19. Half the flux goes via one slanting edge and an air gap 20 to a similar long plate in a similar position, but slightly rotated, forming an air gap of uniform width. The magnetic field goes out through the other slanting edge and passes a similar air gap to a profiled long plate 22 also with slanting edges. The other slanting edge of the profiled long plate 22 faces in the same direction as the others side of the flux distributing rod 18, making it possible for the square rods 23 to pass, without air gaps, the magnetic field to that side and close the magnetic field.

Even the other slanting edge of the long plate 19 on the permanent magnet has a similar magnetic circuit, whose magnetic field is fed back via the other ends of the square rods 23.

In the air gaps there are conductors formed as T-profiles 24 with slits in the roof of the T, in order to prevent current from passing there. The roof of the T-profiles is fastened to the membranes 16, whose edges with elastic strips 25 are affixed in supports on the outside of the long plate 19. The outermost strips 27 are affixed in nonmagnetic struts 28 on the ends of the square rods 23.

The sound currents are fed into the upper conductors and return through the lower conductors.

The permanent magnets can be placed anywhere in the magnetic circuits e. g. two permanent magnets 31 and 32 in the square rods or an permanent magnet 33 in the long plates 19 with beveled sides.

The magnetic flux can also be obtained by an electric current, which goes in a coil, which goes longitudinally around the profiled flux distributing rod 18, and has the cross section 34 and 35. The construction principle is flexible, so that a round propagating loudspeaker, which e. g. can go from floor to ceiling, is illustrated by an arch 29, which is joined to a ring, on which many long plates with beveled sides are fixed. How the construction is continued may be easily perceived and continues in the upper part 36, but is broken by an example of a simple element, which will be described later. In the round propagating loudspeaker the permanent magnets 37 can be placed in the long plate 19 or a form of torus coil can be used going from the center with the cross-section 38 and back into the supports with the cross-section 39. The sound currents then go through the conductors and returns in the long plate 19.

The membranes can be made stiff by building them as trusses. The membrane 16 can be made bent by placing a beam 40 outside the center line and a further plate 41 upon and fixed to the longitudinal edges of the plates. It may also be placed ribs 42 between the plates.

The mentioned simple loudspeaker has a permanent magnet 43, which forces the magnetic field across into an iron rod 44 and out into two parallel air gaps at the sides. In the air gaps there are conductors of L-profiles 45 and 46 with slits in the joins to a plane membrane 47. The magnetic field returns with the mentioned iron structure, which let the sound waves pass. Many loudspeakers can form a cylinder.

A long and narrow loudspeaker, which uses the geomagnetic field will be effective because the magnetic field can be concentrated. Furthermore, the sound pressure can be amplified by a cylindrical exponential horn.

In detail the loud speaker can be made e. g. as on FIG. 3. The earth's magnetic field 51 is caught by a first flux catcher 52, which consists of an iron plate. The flux conductor 54 conveys the magnetic field to flux plates 55 and 56 where the flux conductor is of decreasing thickness. The magnet field passes air gaps 57 and 58 in which horizontal membranes 59 and 60 are placed and reaches the flux plates 61 and 62. There the flux goes over to flux conductors 63 and 64 so that in junction 65 they combine and head towards the flux conductor 66. This goes to a second flux catcher 67 from which the magnetic field 68 exits. The membranes are fed with longitudinal sound currents. The flux catcher can be placed on walls, roofs, masts, in the ground, in wells and mining holes.

This loudspeaker can above all be used where flux unintentionally has arisen. Railway rails in combination with steel roofs over platforms provide the possibility to give the travelers information, which they interpret as coming from an accompanying guide. Also natural flux catchers like ore are usable.

One method to combine sound in a broad corridor with both curves and straights is shown in FIG. 4. The corridor begins lowest down with a straight part 70, where a cylindrical, parabolic reflector 71 is placed on the left wall with a straight loudspeaker 72 in the focus line. Where the corridor turns to the right 73 there is a long bent loudspeaker 74 built of weakly bent or straight loudspeaker elements. A straight loudspeaker would produce a sound level, which decreases with distance. The bending focuses the sound, giving a constant sound level at least within a certain range, which better fits with the plain wave in the earlier part 70, but also to the next part 75, which is straight and has a cylindrical, parabolic reflector 76 and a long loudspeaker 77 to the left.

The next part 78 has a curve to the left. There situated to the left is a long forward bent loudspeaker 79 with e. g. a quarter of a circle rounded membrane 80 and concentrates the sound a distance out from the opposite bent wall, making the sound level almost constant.

The almost constant sound level fits to the plane wave in the straight part 75, but also to the last part 81, which is straight and has a cylindrical, parabolic reflector 82 and a straight loudspeaker 83 to the left.

Sound can in principal be focused through a prism where the material is within special cylinders with arces as generatrixes. The aim can also be to guide away sound e. g. if it is disturbing. Then the cross-section of the prism can be triangular. The acoustic lens can be made of cellular plastic. This is an isotropic material. An acoustic lens where the material is anisotropic, guides the sound better in the desired direction as opposed to perpendicular to it, as shown in FIG. 5. As seen from the perspective of the loudspeaker, it is built of a large convex cylindrical membrane 93, which receives the sound waves from a long and narrow loudspeaker 94 and guides the sound forward by sound conductors 95 of e. g. plates, rods, tubes, grinders or beams to a concave cylindrical membrane 96. Because the sound conductors are longer against the edges of the membrane and the sound velocity in those are higher than in the air, the wave front will be changed from cylindrical to e. g. plain when it propagates out in the air.

It is not possible to prevent the sound from also reflecting from the acoustic lens. If there is a wall behind the loudspeaker it may be necessary to provide it with sound damping material 97. Separately carried sound damping material 98 in the cells between the membranes can be an advantage.

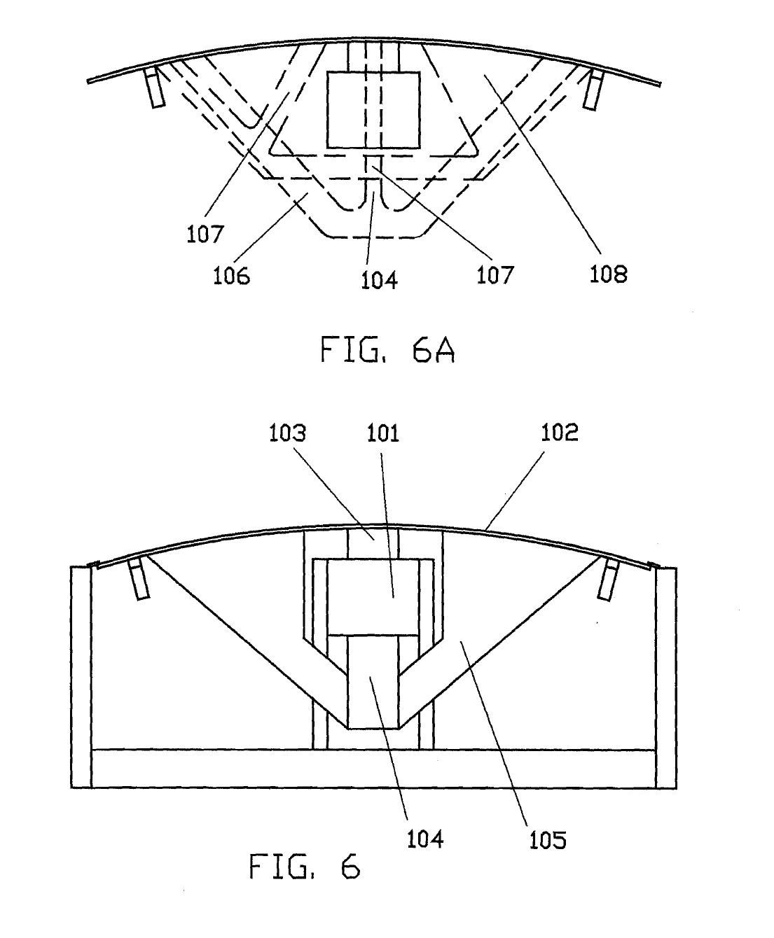

With reference to FIGS. 6-11, the loudspeakers are described with the membrane turned upwards and as a rule with double cross-section.

FIG. 6 shows a simplified cross-section of a long loudspeaker with a driving unit 101. This can be electro-dynamic, piezoelectric, electromagnetic, and perhaps electrostatic or pneumatic systems. The membrane 102 is in the center driven by a upper drive holder 103 from the drive unit and is driven by a lower drive holder 104 from the drive unit via a lower drive distributor 105 in the form of a plate outwards to the edges of the long membrane 102.

One can get driving in the edges with different transferring ways for the movement. FIG. 6A shows that one way is to go down from the drive unit center with drive part and then let the movement with an arm 106 turn out to the membrane edges. Another drive part 107 can go outside and down side the drive unit and turn out to the membrane edges. A beam connected horizontally reduces a bending along a middle line of the membrane.

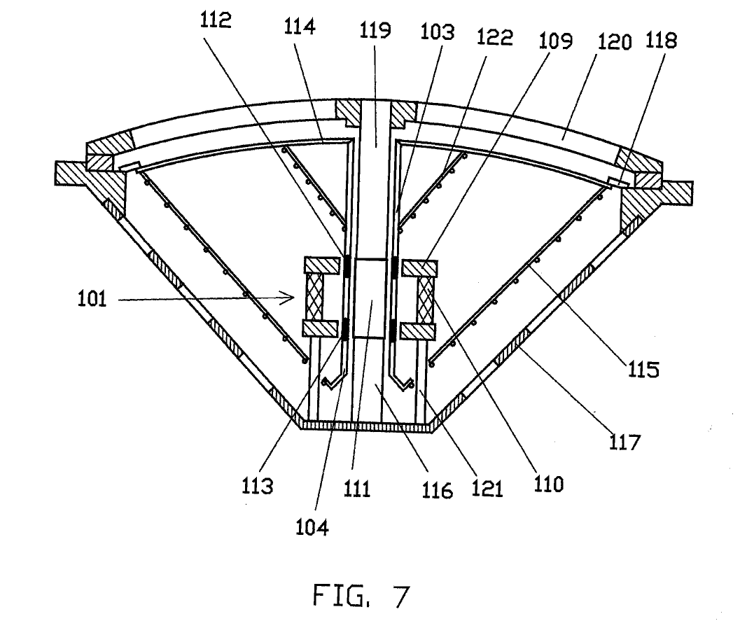

An application to drive at the edges is a round loudspeaker as in FIG. 7. There is a drive unit 101 with a large upper washer 109 and a similar lower washer with a vertical magnetizes permanent magnetic ring 110 in between. Through the washer holes go with play a iron cylinder 11, which has the height of the drive unit and form two ring formed air gaps where the magnetic field goes inward in the one air gap an outwards in the other air gap.

In the air gaps there are coils 112 and 113 on a tube, which do not short voltages. From the upper coil 112 the tube goes further as an upper drive holder 103 up to a bulged membrane 114, which also spreads the treble tones. From the lower coil 113 the tube goes down as a lower drive holder 104 to the bottom of a large net cone 115, which upper edge is close to the membrane periphery.

The iron cylinder 111 stands on a cylinder 116 of different material. It stands in order on the bottom in a basket 117.

In the figure the drive unit with colons 121 is, through holes in the net cone 115, put on the basket bottom. But one can lead in holders in holes to the basket sides and even through holes in the drive holder 103 and 104 directly to the cylinder 111.

The driving of the center of the membrane can be improved with further one net cone 122 from the drive holder 103 up under the membrane 114. The coils shall be feed by tone current in opposite directions.

If the tube between the coils are removed the net cone 115 will be independent driven. The current in the upper coil can be delayed in order to make the movement of the membrane center going synchronized with the movement of the periphery.

There are many possible variations of the principle. Here are a lot of devices given.

Two ordinary electro-dynamic drive units may be coaxially put together and their coil tubes are used as upper and lower drive via net cones. If necessary a delay of the tone current can be made.

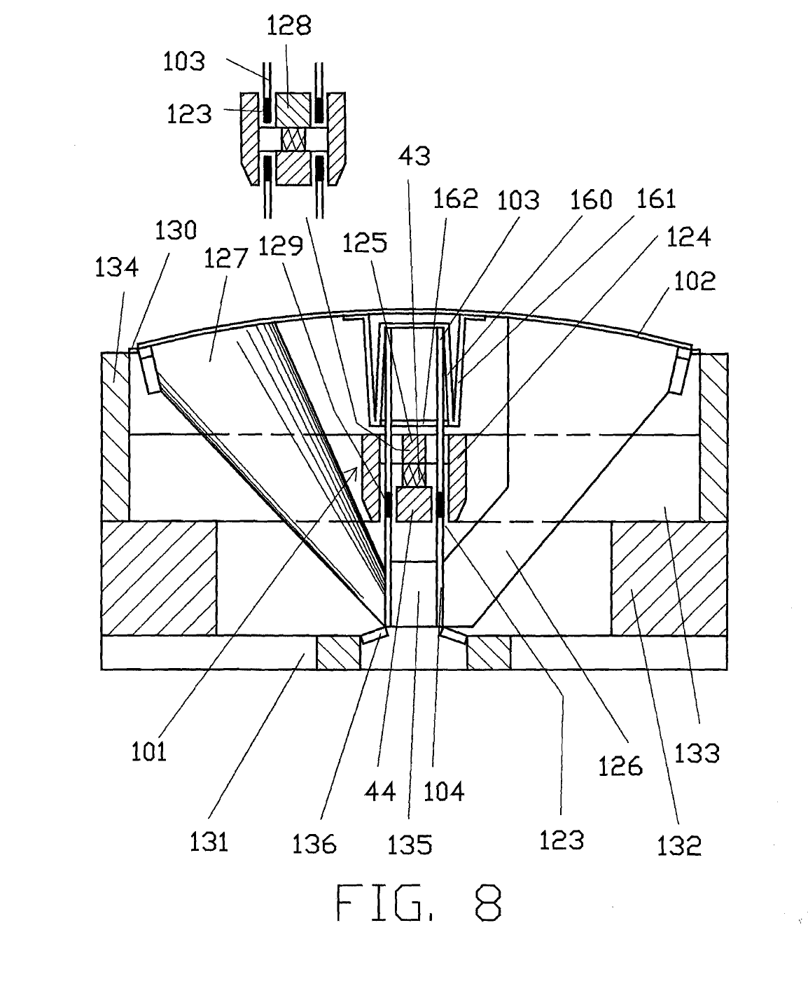

The can be variations in the performance. FIG. 8 shows a cross-section of a long drive unit similar to FIG. 6, which contain a long permanent magnet 43 with the magnetization across and vertically and the one pole at a square rod 44, which are at the left and right of the air gaps 123 to the flat iron 124. The magnetic circuits are closed by cross going blocks 125, which are sitting over the permanent magnet 43 and connect mechanically and magnetically the flat iron 124.

In the air gap 123 conductors of broad bands 129 with slits across both the lower and upper edges to prevent the tone current to go there. The tips in the upper edge go up besides the blocks 125 and become upper drive holder 103 while the tips in the lower edge become lower drive holder 104.

The upper drive holder 103 goes to the center line of the membrane 102, while the lower drive holder 104 via e.g. drive plates 126 go to the edges of the membrane and a small distance before. They become both a rib, which reinforce the membrane. On the left side is used a drive cone 127, which is elliptic at the lower drive holder. If the cone is made of net it will not be bent by the air and move the air.

If the cross blocks in FIG. 8 are exchanged to square rod 128 with the same dimensions as the square rod 44 and if the rods and permanent magnets are given the same width and if the space between the permanent magnet and the flat irons with supporting material, there will be 2 upper and 2 lower air gaps 123. In the air gaps bands with slits are placed. The slits are upper and lower drive holders. Now the current in the upper coil can be delayed to improve the treble. The membrane is along the edges provided with flexible upper suspensions 130 fixed in a long basket of cross going bottom ribs 131, along going carrying bars 132, cross going drive unit support 133, along going side plates 134, where the upper suspension 130 sits between the tips in the lower drive holder 104, which has lower suspensions 136 to the bottom ribs 131.

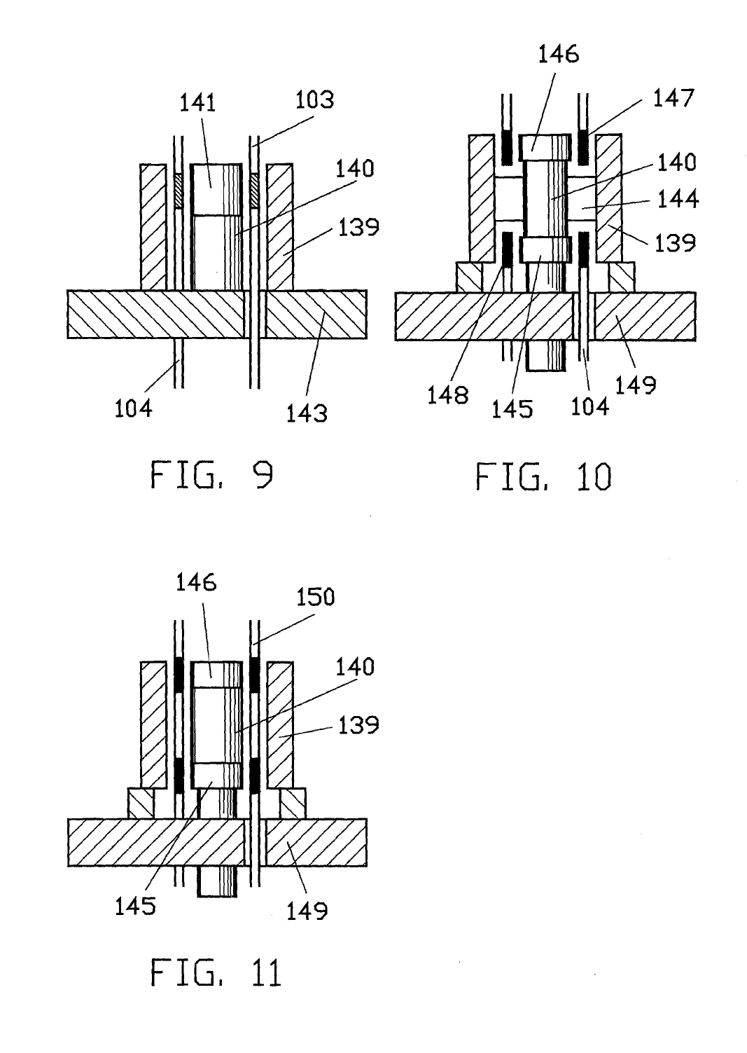

FIG. 9 shows a cylindrically permanent magnet 140 with the poles in its ends, has an iron cylinder 141 on its upper pole, which has air gaps 142 to an outside sitting iron tube 139, which lower inner is filled with a cog plate 143 of iron, on which the permanent magnet stand.

In the air gap there is a coil wounded on an isolated tube, which upper end is upper drive holder 103 on FIG. 7. The lower end changes to rods, which pass the cog plate cogs and become lower drive holder 104.

FIG. 10 shows a cylindrical magnet 140 with the poles in its ends surrounded by a thin non-magnetically supporting ring 144. The permanent magnet 140 stand on a short iron cylinder 145 and upon it stands a similar cylinder 146. The tube 139 reach the outer sides of the cylinders 145 and 146 providing air gaps for an upper coil 147 and lower coil 148 with drive part 104 passing e.g. a cog plate.

On FIG. 11 is shown how the nonmagnetic tube 144 is removed from FIG. 10 and the coils are wounded on the same tube 150, so that they drive together.

The movement of the membrane center can be delayed by e.g. folded strips 160, 161 supported by pins 162 under the drive holder.

While the present invention has been described in accordance with preferred compositions and embodiments, it is to be understood that certain substitutions and alterations may be made thereto without departing from the spirit and scope of the following claims.

1-13. (canceled)

14. A loudspeaker, comprising:
a drive unit for the membrane, one side of the drive unit is attached to a center part of a round membrane or center line of a long membrane via a drive part, a drive distributor and a drive holder; and
another side of the drive unit is attached to membrane edges via a drive part, drive distributor and a drive holder.

15. The loudspeaker according to claim 14 wherein the drive distributor on the one side is a net cone, which goes to the membrane center part and on the another side there is a drive part and a drive distributors like arms, plane plates, wave formed plates, straight cones, beveled cones, which are made of nets.

16. The loudspeaker according to claim 14 wherein the membrane has a stiff structure is wave-formed, creased, corrugated, wing-shaped and conic and the material is a net, of gas pressurized cells, cell plastic, or cell plastic integrated with the drive distributors.

17. The loudspeaker according to claim 14 wherein the drive consist of two or more drives on the same axis and there are drive parts and drive distributors that are beveled-shaped net cones.

18. The loudspeaker according to claim 14 wherein the drive unit contains a long tube with short coils in magnetic field and the tube comes out as drive holder and on the tube other side is modified to pass magnetic and support material as pins, pegs and groves and become drive part and drive holder.

19. The loudspeaker according to claim 14 wherein the drive unit has a tube with two coils that the one tube end become a drive holder and within the tube there is an iron cylinder elongated with other material up to a front grating over the membrane for keeping the loudspeaker parts together and down to the basket on the back side of the loudspeaker and the two coils have means for passing magnetic flux from a magnetic devise containing rings outside the coils between which a ring of permanent magnetic material is sitting, the magnet drive is attached with parts, which pass through the drive distributor to the membrane edge and the parts are fastened to the basket on the loudspeaker back.

20. The loudspeaker according to claim 14 the drive unit contains two pairs of bands lying horizontally in air gaps with magnetic field produced by a long horizontal permanent magnet with the magnetization going cross vertically, on the upper and lower poles are square rods lying with air gaps at the sides to two flat iron, the upper parts of bands have been cut to tips that are attached via drive distributors to the center line of the membrane, the lower parts of bands have been cut to be teeth-shaped in the lower edges, which is attached via drive distributors upwards, outwards to the membrane edges.

21. The loudspeaker according to claim 14 wherein the wave formed plates have a wave with a short wavelength in the one edge and a wave with a long wavelength in the opposite edge.

22. The loudspeaker according to claim 18 wherein the tips, teeth and boxes are booth over and under the coils respective conducting bands.
